(19) United States
(12) Patent Application Publication
(10) Pub. No.: US 2011/0200732 A1
(43) Pub. Date: Aug. 18, 2011

(54) Whipping Agent

(75) Inventors: Friedrich Kielmeyer, Illertissen (DE); Robert Salacz, Blaustein (DE); Christina Reitlinger, Ichenhausen (DE)

(73) Assignee: Cognis IP Management GmbH, Dusseldorf (DE)

(21) Appl. No.: 13/124,587

(22) PCT Filed: Oct. 8, 2009
(86) PCT No.: PCT/EP09/07215

§ 371 Date: Apr. 15, 2011

(30) Foreign Application Priority Data
Oct. 17, 2008 (EP) 08018194.4

(51) Int. Cl. A23L 1/00; A23L 1/035; A23L 1/187; A23P 1/16; A23L 1/19

(52) U.S. Cl. 426/570; 426/564; 426/572; 426/474

(57) ABSTRACT

The present invention relates to a whipping agent comprising at least one fat, at least one protein and at least one emulsifier, wherein the amount of all emulsifiers present in the whipping agent is at least 0.1% by weight of the whipping agent, and wherein the amount of unsaturated fatty acid moieties present in the fat is at least 10% by weight of all fatty acid moieties present in the fat. Furthermore the present invention relates to an instant powder for making an instant powder dessert comprising the whipping agent, a food that comprises a foam that is obtained by whipping, wherein the foam comprises the whipping agent, a process for making the whipping agent and the use of the whipping agent for making a food that comprises a foam that is obtained by whipping.

The present invention relates to a whipping agent comprising at least one fat, at least one protein and at least one emulsifier, wherein the amount of all emulsifiers present in the whipping agent is at least 0.1% by weight of the whipping agent, and wherein the amount of unsaturated fatty acid moieties present in the fat is at least 10% by weight of all fatty acid moieties present in the fat. Furthermore the present invention relates to an instant powder for making an instant powder dessert comprising the whipping agent, a food that comprises a foam that is obtained by whipping, wherein the foam comprises the whipping agent, a process for making the whipping agent and the use of the whipping agent for making a food that comprises a foam that is obtained by whipping.

Whipping agents are well-known products in the food industry. Whipping agents or aerating agents are typically spray-dried compositions comprising fat, one or more emulsifiers and protein. These products are found mainly in instant powder desserts. The dessert is prepared by adding a liquid to the instant powder and by whipping the resulting mixture with a mixer (e.g. Paradiescreme, a product sold by the company Dr. Oetker, Germany). The liquid can be milk or water or another liquid. Such instant formulations typically consist of sugar, a protein source like milk powder, hydrocolloids, coloring agents, flavoring agents and a whipping agent. A whipping agent is necessary in such a formulation so that it can be aerated and so that foam can be built up and so that the air bubbles in the foam are stabilized. The resulting foam is similar to whipped dairy cream. The difference is that no dairy cream is necessary.

Whipping agents can be used in formulations of powder desserts, ready-to-eat applications, cake fillings, decorating creams and other popular applications.

U.S. Pat. No. 3,628,968 discloses a spray-dried whippable food composition prepared of (1) a polyglycerol partial ester of a higher fatty acid, (2) a carbohydrate from the group of starch, dextrin, gums, and sugars and/or fat and (3) acid whey.

WO 02/49445 discloses a powdered fat composition comprising crystallizing fat, proteins, an emulsifier, water and carbohydrates.

EP 1 728 437 A1 discloses an acidic whipping cream comprising acid-soluble soybean protein.

EP 1 723 852 A1 discloses an aerated edible emulsion such as a whipped cream fortified with calcium and comprising at least 2% by weight fat, wherein the fat comprises less than 20% saturated fatty acids. The emulsion may comprise emulsifiers but is preferably substantially free from emulsifier (paragraph 0037). No powdered product comprising fat, emulsifier and protein is disclosed.

For whipping agents mostly hydrogenated oils containing more than 90% saturated fatty acids are used because of their positive impact on whippability, creaminess, mouth feel and texture of the foam obtainable by whipping. Fats like hydrogenated coconut oil or hydrogenated palm kernel oil may be used. They consist of nearly 100% saturated fatty acids. Saturated fatty acids are believed to be an essential component of whipping agents in order to make it possible to provide the whipping agent in powder form and in order to give stability to the foam obtainable after whipping.

Saturated fatty acids, however, should not be present in high amounts in a healthy diet. Therefore, the problem underlying the present invention is to provide a whipping agent having a low content of saturated fatty acids but having good whipping properties.

Surprisingly, it has been found that saturated fatty acids are not an essential component of whipping agents. Surprisingly whipping agents containing oils like sunflower oil, soy bean oil or rape seed oil that contain a high amount of unsaturated fatty acids can have good whipping properties and a stabile foam can be obtained after whipping. Surprisingly whipping agents containing oils that contain a high amount of unsaturated fatty acids can be provided in powder form. This, of course, depends on the composition of the whipping agent and it depends on what other components are present in the whipping agent.

In more detail the problem underlying the present invention is to define a formulation of a whipping agent that leads to good whipping properties that end users are used to get with known whipping agents containing hydrogenated fats and oils. At the same time the formulation must not contain high amounts of saturated fatty acids. At the same time it shall be possible to provide the whipping agent in powder form.

This problem is solved by a whipping agent comprising at least one fat, at least one protein and at least one emulsifier, wherein the at least one emulsifier is different from the at least one protein, and wherein the amount of all emulsifiers present in the whipping agent is at least 0.1% by weight (preferably at least 0.5% by weight, more preferably at least 1% by weight, more preferably at least 5% by weight, more preferably at least 10% by weight) of the whipping agent, and wherein the amount of unsaturated fatty acid moieties present in the fat is at least 10% by weight (preferably at least 30% by weight, more preferably at least 50% by weight, more preferably at least 70% by weight, more preferably at least 90% by weight) of all fatty acid moieties present in the fat. This whipping agent is a subject of the present invention.

One embodiment of the present invention is the whipping agent according to the present invention, wherein this whipping agent is a powder, preferably a powder obtainable by spray-drying.

One embodiment of the present invention is the whipping agent according to the present invention, wherein the emulsifier is selected from the group consisting of a monoglyceride of a fatty acid wherein the fatty acid is either saturated or unsaturated and wherein the fatty acid has 6 to 30 carbon atoms, a diglyceride of two fatty acids wherein both fatty acids, independently of each other, are either saturated or unsaturated and have 6 to 30 carbon atoms, a polyglycerol ester of a fatty acid wherein the fatty acid is either saturated or unsaturated and wherein the fatty acid has 6 to 30 carbon atoms (preferably a polyglycerol monostearat), an acetic acid ester of a monoglyceride of a fatty acid wherein the fatty acid is either saturated or unsaturated and wherein the fatty acid has 6 to 30 carbon atoms, a lactic acid ester of a monoglyceride of a fatty acid wherein the fatty acid is either saturated or unsaturated and wherein the fatty acid has 6 to 30 carbon atoms, a citric acid ester of a monoglyceride of a fatty acid wherein the fatty acid is either saturated or unsaturated and wherein the fatty acid has 6 to 30 carbon atoms, a diacetyl tartaric acid ester of a monoglyceride of a fatty acid wherein the fatty acid is either saturated or unsaturated and wherein the fatty acid has 6 to 30 carbon atoms, lecithin and any mixture of two or more of said emulsifiers.

The definition of the emulsifiers is to be understood as follows. The “a fatty acid” or the “fatty acids” is/are a mixture of fatty acids that fall under the definition given. E.g. “a monoglyceride of a fatty acid wherein the fatty acid is either saturated or unsaturated and wherein the fatty acid has 6 to 30 carbon atoms” can be a mixture of stearic acid monoglyceride and palmitic acid monoglyceride and further monoglycerides.

One embodiment of the present invention is the whipping agent according to the present invention, wherein the protein is selected from the group consisting of milk protein, a protein of plant origin, soy protein, casein, sodium caseinate, calcium caseinate, whey protein concentrate, soy protein hydolysate, pea protein, wheat protein and potato protein.

One embodiment of the present invention is the whipping agent according to the present invention, wherein the fat is liquid at a temperature of 20° C., and wherein the fat is preferably selected from the group consisting of sunflower oil, soy bean oil, rape seed oil, olive oil, safflower oil and fish oil.

One embodiment of the present invention is the whipping agent according to the present invention, wherein the amount of protein present in the whipping agent is 1 to 20% by weight (preferably 3 to 15% by weight, more preferably 4 to 12% by weight, more preferably 5 to 10% by weight) of the whipping agent.

One embodiment of the present invention is the whipping agent according to the present invention, wherein the amount of fat present in the whipping agent is at least 20% by weight (preferably at least 28% by weight, more preferably at least 40% by weight).

One embodiment of the present invention is the whipping agent according to the present invention further comprising mono potassium phosphate, dipotassium phosphate, tetrasodium pyrophosphate, sodium alginate, gelatine, flavour, colour or any mixture of two or more of these components.

Another subject of the present invention is an instant powder for making an instant powder dessert comprising the whipping agent according to the present invention (preferably in an amount of 1 to 70% by weight (more preferably 10 to 50% by weight, more preferably 20 to 40% by weight), optionally further comprising one or more substances selected from the group consisting of sugar, milk powder, a hydrocolloid, a coloring agent and a flavoring agent.

Another subject of the present invention is a food that comprises a foam that is obtained by whipping, wherein the foam comprises the whipping agent according to the present invention (preferably in an amount of 0.1 to 50% by weight, more preferably 5 to 25% by weight, more preferably 10 to 20% by weight), wherein the food optionally further comprises water, milk, milk powder, whey powder, sugar, corn syrup, fructose syrup, starch, modified starch, alginate, carrageenan, locust bean gum, guar gum, xanthan, cellulose, gelatine, agar, pectin, gum Arabic or any mixture of two or more of these components.

The food may be a cake comprising a cake filling which is a foam. The food may be a mousse dessert. In this case the mousse is the foam.

One embodiment of the present invention is the food according to the present invention, wherein this food is a cake comprising a cake filling in the form of a foam, or wherein the food is a cream or a mousse dessert.

One embodiment of the present invention is the food according to the present invention, wherein the food comprises the foam in an amount of 1 to 90% by weight (preferably 10 to 80% by weight, more preferably 20 to 70% by weight).

One embodiment of the present invention is the food according to the present invention, wherein the foam comprises a first phase that is liquid or solid and wherein the foam comprises a second phase that is gaseous and wherein the foam comprises the second phase in an amount of 10 to 80% by volume (preferably 20 to 70% by volume, more preferably 30 to 60% by volume).

Another subject of the present invention is a process for making the whipping agent according to the present invention comprising a) mixing the protein and water so that a first mixture is obtained, b) adding the fat and the emulsifier to the first mixture so that a second mixture is obtained, c) stirring the second mixture, d) spray drying the second mixture so that a powder is obtained and e) optionally cooling the powder.

Another subject of the present invention is the use of the whipping agent according to the present invention for making a food that comprises a foam that is obtained by whipping.

The terms fat and oil are used as synonyms in the context of the present invention. Fats and oils are both substances consisting of esters of glycerol and fatty acids. I.e. a fat contains fatty acid moieties (R—CO—O—) bound to glycerol moieties (C₃H₅(OH)₂ or C₃H₅(OH) or C₃H₅)

The at least one protein in the composition according to the present invention may be any protein. In one embodiment of the present invention this protein is milk protein, in another embodiment it is a protein of plant origin, e.g. soy protein.

An unsaturated fatty acid is a fatty acid having at least one double bond between two adjacent carbon atoms. Preferably the unsaturated fatty acid moieties have 4 to 30 carbon atoms.

The whipping agent according to the present invention has many advantages. It contains only a little amount of saturated fatty acids. It may contain no saturated fatty acids at all. It has good whipping properties. It can be provided in the form of a powder. It has good sensory properties. It does not have any off-taste. It has good oxidation stability. It has good solubility in cold or warm liquids like water or milk.

If the whipping agent according to the present contains an emulsifier that contains saturated fatty acid moieties which many conventional emulsifiers do then it can be advantageous to have a relatively high amount of fat and a relatively low amount of emulsifier in the whipping agent because in this case the higher the amount of fat in the whipping agent according to the present invention in comparison to the amount of emulsifier in the whipping agent according to the present invention is the lower is the content of saturated fatty acid moieties in the whipping agent according to the present invention.

### EXAMPLES

In the examples % is % by weight unless specified otherwise.

Sunflower oil was used as fat (sunflower oil refined and sunflower oil high oleic, both obtainable from the company Gustav Heess GmbH, Germany). The glucose syrup Glucidex® DE 28-32, obtainable from the company Roquette was used, whey protein (Milei 60, obtainable from the company Milei) was used, sodium caseinate (Alanate 180, obtainable from the company NZMP) was used, lactic acid esters of mono- and diglycerides of edible fatty acids were used as emulsifiers (Lamegin® GLP 2410, obtainable from Cognis GmbH, Monheim, Germany), acetic acid esters of mono- and diglycerides of edible fatty acids were used as emulsifiers (Lamegin® EE 30/EE 40, obtainable from Cognis GmbH, Monheim, Germany), mono- and diglycerids of edible fatty acids were used as emulsifiers (Nutrisoft® 55, Monomuls® 90-O18, both obtainable from Cognis GmbH, Monheim, Germany), Polyglycerolmonostearat was used as emulsifier (Propymuls® SPM, obtainable from Cognis GmbH, Monheim, Germany)

Whipping agents having the following compositions have been prepared.

### Example 1

### WT 7590

| fat: | |
|---|---|
| sunflower oil | 28% |
| protein: | |
| whey protein powder | 16% |
| emulsifier: | |
| Lamegin ® GLP 2410 | 14% |
| Nutrisoft ® 55 | 3% |
| others: | |
| glucose syrup | 37.93% |
| sodium alginate | 0.25% |
| tetrapotassium pyrophosphate | 0.8% |
| antioxidant | 0.02% |

### Example 2

### WT 7616

| fat: | |
|---|---|
| sunflower oil | 40% |
| protein: | |
| sodium caseinate | 6% |
| emulsifier: | |
| Lamegin ® EE 40 | 20% |
| Monomuls ® 90-O18 | 2% |
| Nutrisoft ® 55 | 1% |
| others: | |
| glucose syrup | 29.96% |
| Monopotassiumphosphat | 0.25% |
| Dipotassiumphosphat | 0.75% |
| antioxidant | 0.04% |

### Example 3

### WT 7618

| fat: | |
|---|---|
| sunflower oil | 37% |
| protein: | |
| sodium caseinate | 5.5% |
| emulsifier: | |
| Lamegin ® EE 30 | 16% |
| Monomuls ® 90-O18 | 2% |
| others: | |
| glucose syrup | 39.46% |
| antioxidant | 0.04% |

### Example 4

### WT 7668

| fat: | |
|---|---|
| sunflower oil | 28% |
| protein: | |
| sodium caseinat | 6% |
| emulsifier: | |
| Lamegin ® EE 30 | 20% |
| Nutrisoft ® 55 | 1% |
| Monomuls ® 90-O18 | 2% |
| others: | |
| glucose syrup | 42.18% |
| tetrapotassium pyrophosphate | 0.8% |
| antioxidant | 0.02% |

### Example 5

### WT 7672

| fat: | |
|---|---|
| sunflower oil | 40% |
| protein: | |
| sodium caseinat | 6% |
| emulsifier: | |
| Lamegin ® EE 30 | 20% |
| Nutrisoft ® 55 | 1% |
| Monomuls ® 90-O18 | 2% |
| others: | |
| glucose syrup | 30.18% |
| tetrapotassium pyrophosphate | 0.8% |
| antioxidant | 0.02% |

### Example 6

### WT 7704

| fat: | |
|---|---|
| sunflower oil | 40% |
| protein: | |
| sodium caseinat | 8% |
| emulsifier: | |
| Propymuls ® SPM | 20% |
| others: | |
| glucose syrup | 31.96% |
| antioxidant | 0.02% |

The whipping agents were tested in typical applications to evaluate their properties. The whipping agents according to examples 1 to 6 were compared to a standard whipping agent according to the state of the art (LQ CE 6630).

### Preparation of Foams

As a basic testing method to evaluate aerating capacity and softness of a foam obtained after whipping a composition comprising a whipping agent the following recipe was used:

35 g whippinig agent, 10 g sugar and 125 ml milk.

The whipping agent and the sugar were poured together in a bowl. After adding the milk the mix was whipped up with a spiral mixer (e.g. a Hobart N 50).

The Relative Volumes of the Foams were Determined as Follows:

A glass dish was weighed before and after filling it with the whipped foam. The difference was the weight of the aerated cream of known volume. This weight was used to calculate the relative volume. The relative volume is expressed as milliliter (ml) per 100 g.

$$\frac{Volume of the dish ( ml ) \times 100}{weight of the aerated cream ( g )} = relative volume in ml per 100 g$$

### The Softness of the Foams was Determined as Follows:

The whipped product was filled into a glass dish. A metal disc of a defined weight (88 g) was placed directly above the foam surface without touching it. The disc was then dropped into the foam for 10 seconds. The distance, the disc penetrates into the foam, was measured in Penetrometer Units (PE units). The softer the foam was, the deeper the disc penetrated and the higher the PE value was. PE was determined immediately after the preparation of the foam (“PE 88 g fresh”) and after cooling the foam for 30 minutes (“PE 88 g 30 min refrigeration”).

The Following Food Products Comprising a Foam that was Obtained as Described Above were Made and Tested:

### A Vanilla Dessert:

| | | |
|---|---|---|
| whip topping (=foam) | 30 | g |
| sugar | 40 | g |
| potatoe starch | 4 | g |
| instant gelatine | 6 | g |
| flavour | 1 | g |
| milk | 200 | ml |

### A Chocolate Mousse Dessert:

| | | |
|---|---|---|
| whip topping (=foam) | 30 | g |
| Sugar | 49.9 | g |
| potatoe starch | 5 | g |
| instant gelatine | 6 | g |
| cocoa powder | 14 | g |
| inulin | 5 | g |
| flavour | 0.15 | g |
| milk | 200 | ml |

### A Low pH Dessert:

| | | |
|---|---|---|
| whip topping (=foam) | 35 | g |
| sugar | 69.6 | g |
| potatoe starch | 3 | g |
| instant gelatine | 5 | g |
| citric acid | 1 | g |
| color (2%) | 1 | g |
| flavour | 0.43 | g |
| milk | 200 | ml |

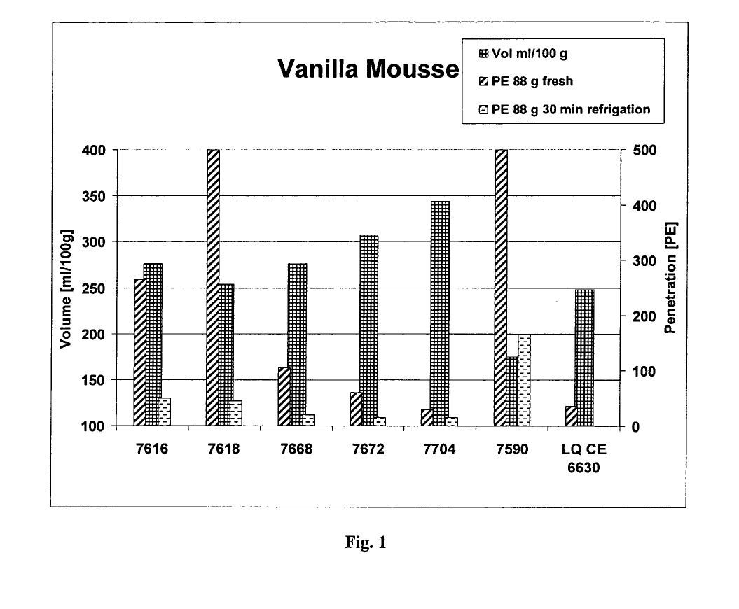

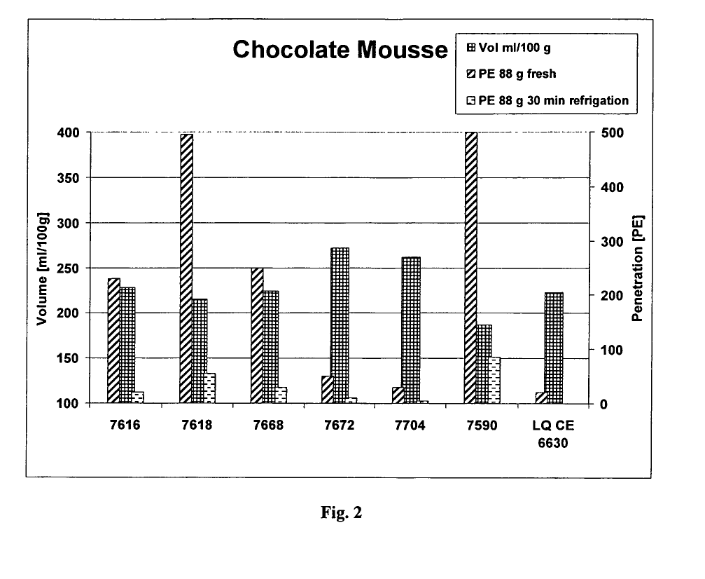

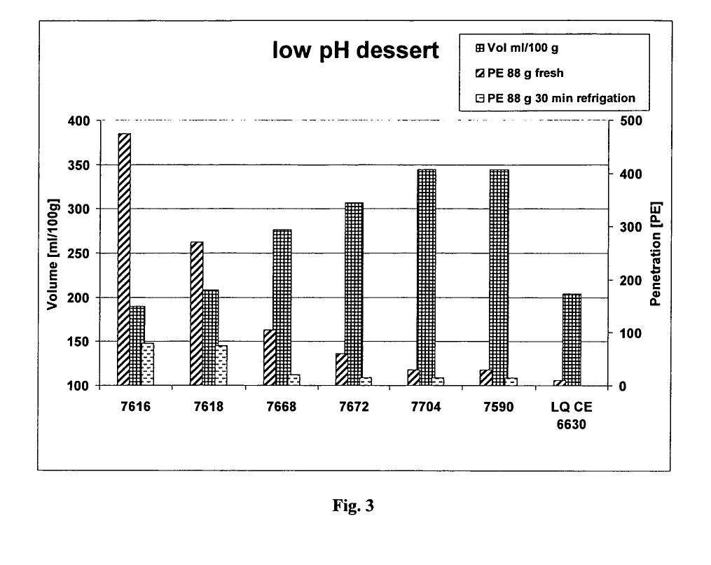

The results are shown in FIGS. 1 to 3. Volume and stability (penetration) of the foams obtained with the whipping agents according to the present invention are on a typical level compared to the foam obtained with the whipping agent according to the state of the art (Lamequick® CE 6630, abbreviated LQ CE 6630). The value of “PE 88 g 30 min refrigeration” is zero in all three figures in the case of LQ CE 6630. “Typical level” means a volume of about 200 ml per 100 g and a high value of “PE 88 g fresh” (i.e. the freshly prepared foam is soft) that becomes lower after 30 min refrigeration (i.e. the foam becomes harder).

1. A whipping agent comprising
at least one fat,
at least one protein and
at least one emulsifier,
wherein the at least one emulsifier is different from the at least one protein, and
wherein the amount of all the at least one emulsifiers present in the whipping agent is at least 0.1% by weight of the whipping agent, and
wherein the amount of unsaturated fatty acid moieties present in the at least one fat is at least 10% by weight of all fatty acid moieties present in the at least one fat.

2. The whipping agent according to claim 1, wherein the whipping agent is a powder, preferably a powder obtainable by spray-drying.

3. The whipping agent according to claim 1, wherein the at least one emulsifier is selected from the group consisting of
a monoglyceride of a fatty acid wherein the fatty acid is either saturated or unsaturated and wherein the fatty acid has 6 to 30 carbon atoms,
a diglyceride of two fatty acids wherein both fatty acids, independently of each other, are either saturated or unsaturated and have 6 to 30 carbon atoms,
a polyglycerol ester of a fatty acid wherein the fatty acid is either saturated or unsaturated and wherein the fatty acid has 6 to 30 carbon atoms (preferably a polyglycerol monostearat),
an acetic acid ester of a monoglyceride of a fatty acid wherein the fatty acid is either saturated or unsaturated and wherein the fatty acid has 6 to 30 carbon atoms,
a lactic acid ester of a monoglyceride of a fatty acid wherein the fatty acid is either saturated or unsaturated and wherein the fatty acid has 6 to 30 carbon atoms,
a citric acid ester of a monoglyceride of a fatty acid wherein the fatty acid is either saturated or unsaturated and wherein the fatty acid has 6 to 30 carbon atoms,
a diacetyl tartaric acid ester of a monoglyceride of a fatty acid wherein the fatty acid is either saturated or unsaturated and wherein the fatty acid has 6 to 30 carbon atoms,
lecithin
and any mixture of two or more of the at least one emulsifier.

4. The whipping agent according to claim 1, wherein the at least one protein is selected from the group consisting of milk protein, a protein of plant origin, soy protein, casein, sodium caseinate, calcium caseinate, whey protein concentrate, soy protein hydolysate, pea protein, wheat protein and potato protein.

5. The whipping agent according to claim 1, wherein the at least one fat is liquid at a temperature of 20° C., and wherein the at least one fat is preferably selected from the group consisting of sunflower oil, soy bean oil, rape seed oil, olive oil, safflower oil and fish oil.

6. The whipping agent according to claim 1, wherein the amount of the at least one protein present in the whipping agent is 1 to 20% by weight of the whipping agent.

7. The whipping agent according to claim 1, wherein the amount of the at least one fat present in the whipping agent is at least 20% by weight.

8. The whipping agent according to claim 1, further comprising mono potassium phosphate, dipotassium phosphate, tetrasodium pyrophosphate, sodium alginate, gelatine, flavour, colour or any mixture of two or more of these components.

9. An instant powder for making an instant powder dessert comprising the whipping agent according to claim 1, optionally further comprising one or more substances selected from the group consisting of sugar, milk powder, a hydrocolloid, a coloring agent and a flavoring agent.

10. A food that comprises a foam that is obtained by whipping, wherein the foam comprises the whipping agent according to claim 1, wherein the food optionally further comprises water, milk, milk powder, whey powder, sugar, corn syrup, fructose syrup, starch, modified starch, alginate, carrageenan, locust bean gum, guar gum, xanthan, cellulose, gelatine, agar, pectin, gum Arabic or any mixture of two or more of these components.

11. The food according to claim 10, wherein the food is a cake comprising a cake filling in the form of a foam, or wherein the food is a cream or a mousse dessert.

12. The food according to claim 10, wherein the food comprises the foam in an amount of 1 to 90% by weight.

13. The food according to claim 10, wherein the foam comprises a first phase that is liquid or solid and wherein the foam comprises a second phase that is gaseous and wherein the foam comprises the second phase in an amount of 10 to 80% by volume.

14. A process for making the whipping agent according to claim 1 comprising
a) mixing the at least one protein and water so that a first mixture is obtained,
b) adding the at least one fat and the at least one emulsifier to the first mixture so that a second mixture is obtained,
c) stirring the second mixture,
d) spray drying the second mixture so that a powder is obtained and
e) optionally cooling the powder.

15. A process for using the whipping agent according to claim 1 for making a food that comprises a foam that is obtained by whipping.

16. The whipping agent according claim 2, wherein the at least one emulsifier is selected from the group consisting of
a monoglyceride of a fatty acid wherein the fatty acid is either saturated or unsaturated and wherein the fatty acid has 6 to 30 carbon atoms,
a diglyceride of two fatty acids wherein both fatty acids, independently of each other, are either saturated or unsaturated and have 6 to 30 carbon atoms,
a polyglycerol ester of a fatty acid wherein the fatty acid is either saturated or unsaturated and wherein the fatty acid has 6 to 30 carbon atoms (preferably a polyglycerol monostearat),
an acetic acid ester of a monoglyceride of a fatty acid wherein the fatty acid is either saturated or unsaturated and wherein the fatty acid has 6 to 30 carbon atoms,
a lactic acid ester of a monoglyceride of a fatty acid wherein the fatty acid is either saturated or unsaturated and wherein the fatty acid has 6 to 30 carbon atoms,
a citric acid ester of a monoglyceride of a fatty acid wherein the fatty acid is either saturated or unsaturated and wherein the fatty acid has 6 to 30 carbon atoms,
a diacetyl tartaric acid ester of a monoglyceride of a fatty acid wherein the fatty acid is either saturated or unsaturated and wherein the fatty acid has 6 to 30 carbon atoms,
lecithin,
and any mixture of two or more of the at least one emulsifier.

17. The whipping agent according to claim 3, wherein the at least one protein is selected from the group consisting of milk protein, a protein of plant origin, soy protein, casein, sodium caseinate, calcium caseinate, whey protein concentrate, soy protein hydolysate, pea protein, wheat protein and potato protein.

18. The whipping agent according to claim 4, wherein the at least one fat is liquid at a temperature of 20° C., and wherein the at least one fat is preferably selected from the group consisting of sunflower oil, soy bean oil, rape seed oil, olive oil, safflower oil and fish oil.

19. The whipping agent according to claim 3, wherein the amount of the at least one protein present in the whipping agent is 1 to 20% by weight of the whipping agent.

20. The whipping agent according to claim 3, wherein the amount of the at least one fat present in the whipping agent is at least 20% by weight.
